(19) United States
(12) Patent Application Publication
(10) Pub. No.: US 2025/0187937 A1
(43) Pub. Date: Jun. 12, 2025

(54) PLASMA SYSTEM AND PROCESS FOR FORMATION AND RECOVERY OF METAL CARBONATES FROM BRINE SOLUTION

(71) Applicant: Southwest Research Institute, San Antonio, TX (US)

(72) Inventors: Vasiliki Zorbas POENITZSCH, Alamo Heights, TX (US); Josh MANGUM, Sarasota, FL (US); Armando RIOS, San Antonio, TX (US)

(21) Appl. No.: 18/966,408

(22) Filed: Dec. 3, 2024

Related U.S. Application Data
(60) Provisional application No. 63/608,369, filed on Dec. 11, 2023.

(51) Int. Cl. C01D 15/08; C01D 7/00; C01F 5/24; C01F 11/18

(52) U.S. Cl. CPC C01D 15/08; C01D 7/00; C01F 5/24; C01F 11/18; C01P 2004/03

(57) ABSTRACT

A system and method that utilize a non-thermal plasma (NTP) for formation and recovery of metal carbonates from brine solution.

### FIELD

The present invention is directed at a system and method that utilizes a non-thermal plasma (NTP) for formation and recovery of metal carbonates from brine solution.

### BACKGROUND

Numerous commercial applications are reported for lithium, including its minerals and various lithium salts, including lithium carbonate, lithium hydroxide and lithium halides. Such applications span across many diverse sectors such as electronics, pharmaceuticals and ceramics. Notably, lithium finds applications in lithium batteries as well as lubricant greases, and in other commercial fields.

Consequently, commercial production of lithium carbonate (Li₂CO₃) as a source of lithium has involved two primary sources: extraction from pegmatite mineral sources through conventional mining procedures; and (2) recovery from lithium-containing brines. Lithium-containing brine is reference herein to saline water that contains lithium. Accordingly, lithium-containing brines may typically include naturally occurring, geothermal and oilfield sourced brines.

Lithium extraction refers to a set of chemical processes where lithium may be isolated from a sample and converted to a commercial grade of lithium. However, the conventional extraction procedure is a relatively lengthy procedure that can take several months to a few years to complete. The extraction procedure also typically involves the use of relatively large amounts of fresh water, chemicals and energy. In addition, the extraction procedure is not applicable to relatively dilute brines, such as oilfield brines.

Alternative technologies to extraction are currently identified as direct lithium extraction (DLE). Such DLE procedures have been identified to include the use of ion-exchange resins, selective membranes, nanofiltration, electrochemical methodologies and thermal-assisted techniques.

U.S. Pat. No. 11,708,279 entitled SELECTIVE MATERIAL RECOVER FROM SOLUTION recites methods for generating selected materials from natural brine. The process involves heating natural brine and adding CO₂ and forming a mixture and holding the mixture until solid precipitates are formed and removed and forming a second brine. This is followed by adding CO₂ to form a second mixture and heating and adding additional CO₂ and holding until selected material precipitates and removing the selected material. The selected material is identified to include a carbonate.

WO2010/006366 entitled A PROCESS FOR RECOVERING LITHIUM FROM A BRINE recites adjusting the pH of a feed brine containing lithium to a value of no less than 11.3 and separating the waste solids and a solution containing lithium values. The solution may be further concentrated and treated to obtain lithium carbonate and a lithium chloride solution suitable for obtaining electrolytic grade lithium chloride.

### SUMMARY

A method for forming a metal carbonate comprising: (a) supplying a brine solution containing a dissolved metal ion; (b) generating a non-thermal plasma in the presence of carbon dioxide (CO₂) wherein an output of said non-thermal plasma contacts said brine solution; and (c) forming a metal carbonate in said brine solution.

A system for forming a metal carbonate comprising: a brine solution containing a dissolved metal ion and a non-thermal plasma apparatus that outputs a carbonate anion wherein the output of carbonate anion is configured to contact the brine solution and form the metal carbonate.

### BRIEF DESCRIPTION OF THE DRAWINGS

FIG. 1A illustrates a preferred non-thermal plasma system in combination with a brine solution for recovery of metal carbonates.

FIG. 1B illustrates the preferred non-thermal plasma system illustrating the formation of an insoluble metal carbonate.

FIG. 1C illustrates the separation of the metal carbonate from the plasma system and brine solution.

FIG. 2A is a photograph of a preferred non-thermal plasma system in combination with a brine solution for recovery of metal carbonates.

FIG. 2B is a photograph showing recovery of a metal carbonate from the preferred non-thermal plasma system.

FIG. 3 is a scanning electron microscopy (SEM) image of recovered calcium carbonate from the preferred non-thermal plasma system.

FIG. 4 is an elemental analysis of the recovered calcium carbonate from the preferred non-thermal plasma system.

### DETAILED DESCRIPTION

The present invention stands directed at a system and process that utilizes a non-thermal plasma for recovery of metal carbonates from brine solution. The brine solution contains a dissolved metal ion, such as lithium (Li⁺¹), calcium (Ca⁺²), magnesium (Mg²⁺) or sodium (Na⁺¹). A non-thermal plasma (NTP) herein is understood as the generation of electrically energized matter in a gaseous state that can be generated by passing working gases, such as carbon dioxide, through an electric field. NTP, also referred to as cold plasma or non-equilibrium plasma, is also understood as a plasma that is not in thermodynamic equilibrium, since the electron temperature is relatively hotter than the temperature of the ions and neutral species (atoms). Accordingly, NTP can provide a source of relatively high-temperature electrons (e.g., 10,000 K to 50,000 K), with neutral particles and ions at relatively low temperature (e.g., 298 K to 373 K). Such plasma may preferably be produced by application of a relatively high voltage across a relatively high voltage electrode spaced apart from a ground electrode at atmospheric pressure.

As noted, brine solution herein containing a metal ion such as lithium, calcium, magnesium or sodium, is preferably a naturally occurring brine, geothermal and/or oilfield sourced brine. As described herein in further detail, the present invention is particularly suitable for lithium-containing brine but should be understood to apply to brines containing calcium, magnesium or sodium, where such elements are also now desirably recovered. In addition, in the case of lithium, the brines are contemplated herein to include a preferred level of lithium in the range of 10 mg/L to 2000 mg/L, including all values and increments therein.

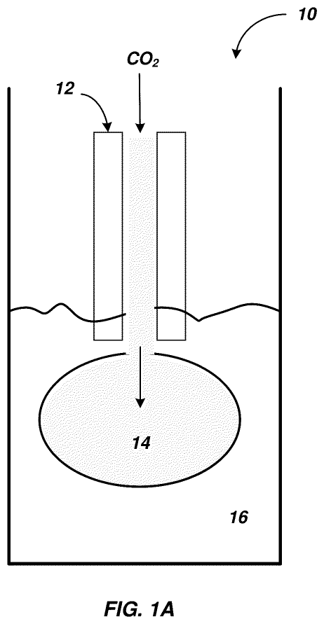

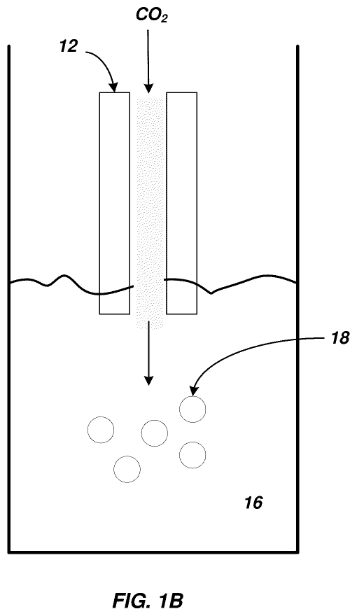

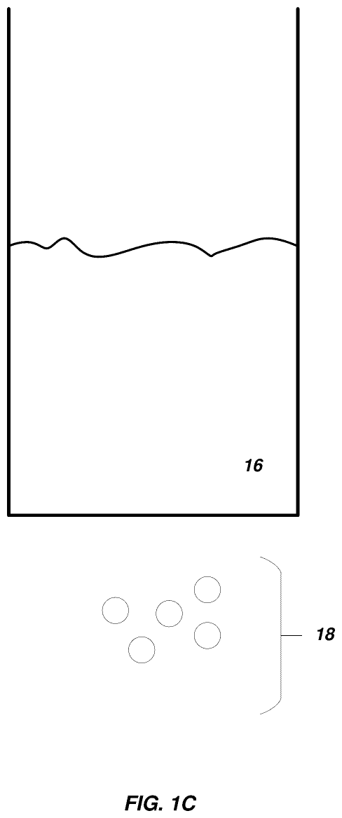

FIGS. 1A, 1B and 1C provide a schematic sequenced overview of the preferred system and method herein. Starting with FIG. 1A, the plasma system 10 herein for recovery of metal carbonates includes a non-thermal plasma apparatus having a plasma head unit 12 for application of a relatively high voltage across a high voltage electrode that optionally includes a dielectric barrier spaced from a ground electrode. Carbon dioxide (CO₂) as the working gas is then introduced between such electrodes, and the plasma that is formed is identified at 14 which is then configured to contact brine solution 16 containing dissolved lithium. Preferably, the plasma output is, as illustrated, submerged beneath the surface of the brine solution. However, in the broad context of the present invention, the plasma output may occur above the surface of the brine solution and then contact with the surface brine solution.

More specifically, it can now be understood that the NTP creates ionization of CO₂ feed gas and generation of carbon ions, oxygen ions, radicals and electrons which subsequently react and form an output of carbonate ions (CO₃²⁻) in the brine solution 16. Preferably, the flow rate of CO₂ falls in the range of 500 standard cubic centimeters per minute (sccm) to 40,000 sccm. In addition, one may optionally include the use of CO₂ mixed with nitrogen, air, argon, helium or other inert gases.

As shown in FIG. 1B, the carbonate ions (CO₃²⁻) can then react with the lithium metal ions (Li⁺) in solution resulting in the formation of the insoluble metal carbonate, namely lithium carbonate (Li₂CO₃) which is identified at 18. As shown in FIG. 1C, the lithium carbonate 18 may then be readily separated from the brine solution 16, which may preferably be achieved via the use of mechanical filtration and/or centrifugation, thereby providing a source of lithium. It should therefore be appreciated that in the case of a brine solution containing calcium, one may now similarly recover calcium carbonate (CaCO₃), in the case of a brine solution containing magnesium, one may recover magnesium carbonate (MgCO₃), and in the case of brine solution containing sodium, one may recover sodium carbonate (Na₂CO₃).

As can also be appreciated from the above, and in preferred embodiment, directing the output of a non-thermal plasma (NTP) utilizing CO₂ as the carrier gas into a brine solution having dissolved metal ion (Li⁺¹, Ca⁺², Mg⁺² or Na⁺¹) does not require heat treatment of such brine solution. Heating of the brine solution is therefore entirely optional. In addition, the pH of the brine solution can vary, and may preferably fall in the range of 6 and higher, more preferably a pH of 6 to a pH of 11.

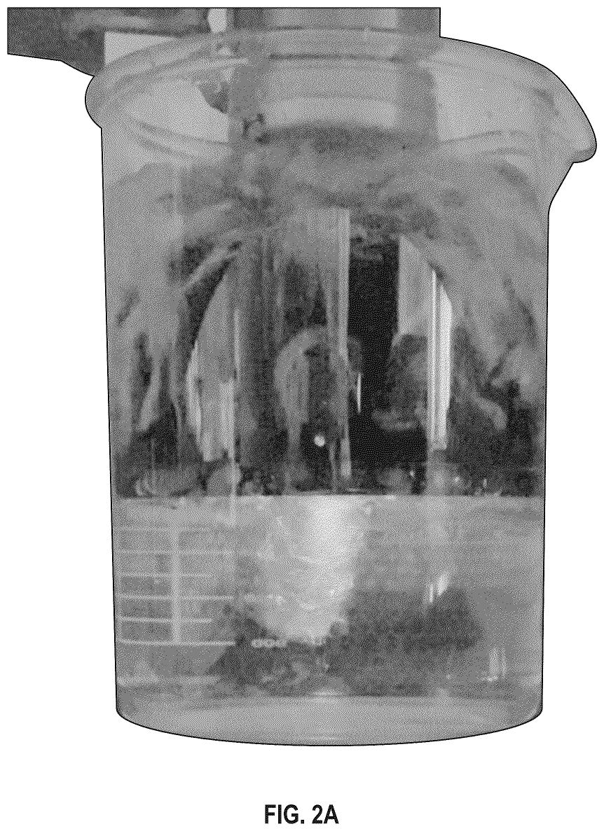

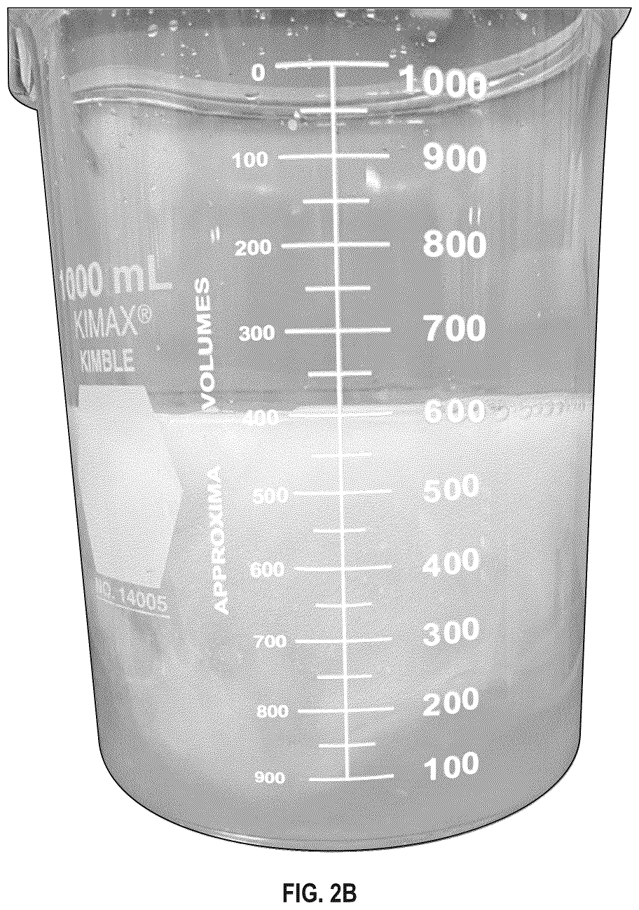

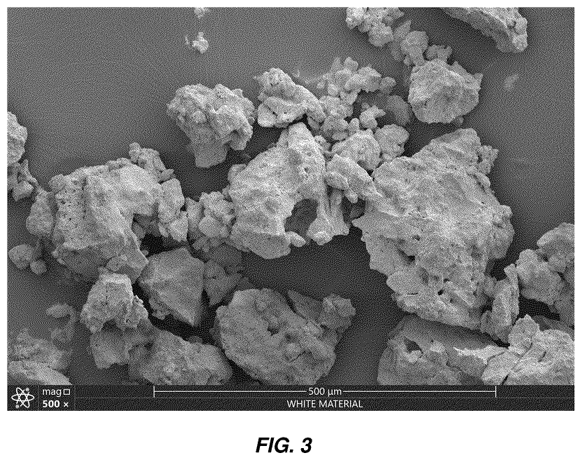

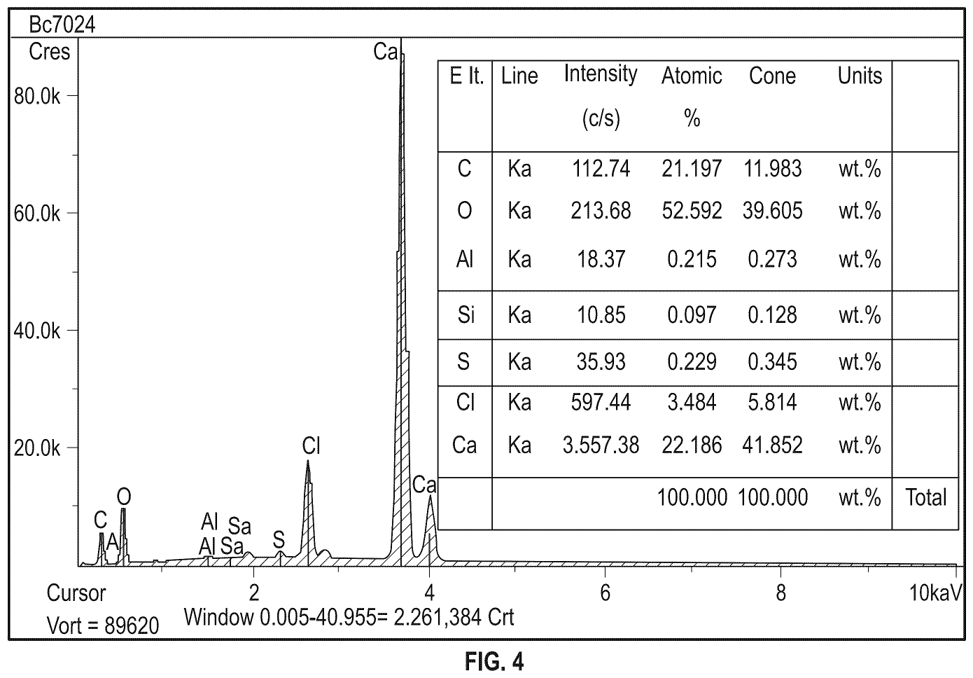

FIG. 2A next shows a photograph of an atmospheric NTP using CO₂ as the carrier gas operating in a brine solution containing calcium. In that regard, FIG. 2A shows an actual working NTP plasma output in a calcium brine solution as schematically presented in FIG. 1A. FIG. 2B shows the resulting formation and recovery of calcium carbonate insoluble particles. FIG. 3 is a scanning electron microscopy (SEM) image of the recovered calcium carbonate particles. FIG. 4 is an elemental analysis of the recovered particles confirming the presence of calcium carbonate.

What is claimed is:

1. A method for forming a metal carbonate comprising:
a. supplying a brine solution containing a dissolved metal ion;
b. generating a non-thermal plasma in the presence of carbon dioxide (CO₂) wherein an output of said non-thermal plasma contacts said brine solution; and
c. forming a metal carbonate in said brine solution.

2. The method of claim 1, including the step of recovering said metal carbonate from said brine solution.

3. The method of claim 1, wherein generating a non-thermal plasma comprises passing carbon dioxide through an electric field and generating carbonate anions (CO₃²⁻) in said brine solution.

4. The method of claim 1, wherein the CO₂ is at a flow rate of 500 sccm to 40,000 sccm.

5. The method of claim 1, wherein said brine solution is at a pH of 6 or higher.

6. The method of claim 5, wherein said brine solution is at a pH of 6 to a pH of 11.

7. The method of claim 1, wherein said brine solution contains dissolved lithium ion and said metal carbonate comprises lithium carbonate.

8. The method of claim 1, wherein said brine solution contains dissolved calcium ion and said metal carbonate comprises calcium carbonate.

9. The method of claim 1, wherein said brine solution contains dissolved magnesium ion and said metal carbonate comprises magnesium carbonate.

10. The method of claim 1, wherein said brine solution contains dissolved sodium ion and said metal carbonate comprises sodium carbonate.

11. The method of claim 1, wherein said brine solution comprises a naturally occurring brine, geothermal and/or oilfield sourced brine.

12. The method of claim 1, wherein said brine solution has a surface and said output of said non-thermal plasma is submerged beneath said surface of said brine solution.

13. A system for forming a metal carbonate comprising:
a. a brine solution containing a dissolved metal ion;
b. a non-thermal plasma apparatus that outputs a carbonate anion wherein said output of carbonate anion is configured to contact said brine solution and form said metal carbonate.

14. The system of claim 13, wherein said brine solution is at a pH of 6 or higher.

15. The system of claim 14, wherein said brine solution is at a pH of 6 to a pH of 11.

16. The system of claim 13, wherein said carbonate anion is sourced from carbon dioxide.

17. The system of claim 13, wherein said non-thermal plasma apparatus includes a flow of carbon dioxide at a flow rate of 500 sccm to 40,000 sccm.

18. The system of claim 13, wherein said metal carbonate comprises lithium carbonate.

19. The system of claim 13, wherein said metal carbonate comprises calcium carbonate.

20. The system of claim 13, wherein said metal carbonate comprises magnesium carbonate.

21. The system of claim 13, wherein said metal carbonate comprises sodium carbonate.
